(19) United States
(12) Patent Application Publication
(10) Pub. No.: US 2026/0239006 A1
(43) Pub. Date: Aug. 13, 2026

(54) Technology for Transmitting Data Using a Telematics Connection for a Motor Vehicle

(71) Applicant: Bayerische Motoren Werke Aktiengesellschaft, Muenchen (DE)

(72) Inventor: Matthias FINK, Muenchen (DE)

(21) Appl. No.: 19/532,461

(22) Filed: Feb. 6, 2026

(30) Foreign Application Priority Data
Feb. 7, 2025 (DE) 10 2025 104 629.8

(51) Int. Cl. H04W 12/06; B60R 25/24; H04W 4/40

(52) U.S. Cl. CPC H04W 12/068; B60R 25/24; H04W 4/40; B60R 2325/108

(57) ABSTRACT

A method for transmitting data using a telematics connection for a motor vehicle comprises providing the data for the transmission; providing a one-time key for the data; and transmitting the one-time key via the telematics connection to the motor vehicle.

### CROSS REFERENCE TO RELATED APPLICATION

This application claims priority under 35 U.S.C. § 119 from German Patent Application No. 10 2025 104 629.8, filed Feb. 7, 2025, the entire disclosure of which is herein expressly incorporated by reference.

### BACKGROUND AND SUMMARY

The invention relates to methods for transmitting data using a telematics connection for a motor vehicle, and relates in particular, to methods for transmitting metadata of a digital vehicle key using such a telematics connection, which provides a secured communication channel.

Presently, almost every vehicle has a telematics system, which interacts with a backend provided by the vehicle producer. Stated generally, such a telematics system can comprise a combination of a telecommunication unit and an informatics unit in order to collect data, for example, from a sensor system of the vehicle and transmit these data to the backend. Such a system permits the backend to analyze aspects such as vehicle performance, driving behavior, fleet management, etc. However, the bandwidth of such telematics connections is limited, both because of the resources available in practice in the vehicle and also because of varying connection quality when the vehicle is driving, is parked in an underground garage, etc.

Various telematics connections or channels can be present or established to various endpoints in the vehicle. The endpoints can be located, for example, in different ECUs and therefore different resources can also be available for the telematics connections. Especially high-security channels which end in secure vehicle components can be very limited with respect to a bandwidth due to the hardware resources available in practice, such as processor performance, working memory, etc. Data which are to be transmitted in a secured manner in conjunction with a digital key, for example, can be very extensive in relation to the available bandwidth, however.

Digital keys, in particular vehicle keys, are known per se. Thus, the “Car Connectivity Consortium” (CCC) defines, with the “Digital Key Release 3” in the form of a technical specification, a standard for a digital vehicle key. In this context, for example, an application or app of a vehicle producer or also a service provider can be installed on a terminal of a vehicle owner, which enables access to a vehicle, enables control of specific vehicle functions, etc. by means of a digital vehicle key held on the device (for example, in a secure memory of the device).

A use of the key is based on interfaces between the secure memory and an operating system of the device, and between the operating system and other applications or apps which are executed on the device. Expanded possible uses additionally result from the presence of a backend system for key management, i.e. management of the digital vehicle key.

As stated, data which have to be transmitted in secured form, thus, for example, encrypted, for such a digital key can be very extensive, in particular if these data comprise, for example, personal data. More precisely, a transmission of such data via a high-security telematics channel can be problematic if the endpoint of the channel is located in an embedded high-security zone (for example, a secure element) having very limited resources, because then the decryption, buffering, error correction, etc. cost a substantial part of the available resources. During the secure transmission of a large data block, stoppages can occur, data errors can occur, the data transmission possibly has to start from the beginning, etc. The transmission of a large data block can then also impair, delay, etc. other functions of a secure memory.

There is a demand for improved concepts for handling extensive data which are to be transmitted via a high-security telematics channel having limited bandwidth. In particular, this relates to applications such as synchronizing or updating metadata for digital keys, for which it is to be expected in the future that the problems mentioned will become more and more relevant.

One object underlying the present invention is to provide an improved technical concept for a data transmission via a telematics connection to a vehicle. The invention achieves this object by means of the subjects of the independent claims. Dependent claims reflect preferred embodiments.

A first aspect of the present invention relates to a method for transmitting data using a telematics connection for a motor vehicle. The method can be implemented in a backend server such as a central vehicle producer server. The method comprises providing the data for the transmission (or causing the data to be provided for the transmission); providing a one-time key for the data (or causing a one-time key to be provided for the data); and transferring the one-time key via the telematics connection to the motor vehicle (or causing the access designator to be transferred via the telematics connection to the motor vehicle).

In various embodiments, the telematics connection can in general be a communication connection. For example, the communication connection can comprise a mobile wireless connection, but can also comprise a connection function such as Bluetooth, Wi-Fi, WLAN (“Wireless Local Area Network”), Bluetooth Low Energy, NFC (“Near Field Communication”), UWB (“Ultra-Wide-Band”), and/or another, possibly future connection function.

It is to be expressly noted that the term “connection” is used for clarity and comprehension herein with reference to a transmission of the or any data. Therefore, the term “connection” is to comprise both connection-oriented transmission protocols and also connection-free transmission protocols.

A one-time key is understood as a cryptographic key which is intended for one-time use, thus, for example, for one-time encryption and decryption of data. A one-time key can be a symmetrical key, a key which is shared via a different path than the data, etc.

In some embodiments of the invention, the data comprise, for example, metadata for a digital key, in particular a vehicle key for example, according to CCC. Such metadata can comprise, for example, an access token, ID token, etc.

In certain embodiments of this aspect of the invention, the data are provided in encrypted form for retrieval by means of an access designator. The encryption of the data can take place, for example, by means of the one-time key. The access designator can be an arbitrary designator which enables access to a resource such as data, a data block, etc., thus, for example, enables retrieval of the data, etc. The access designator can thus comprise, for example, an identifier (“ID”), an ID number, an address, a link, a pointer, a URI (“Uniform Resource Indicator”), a URL (“Uniform Resource Locator”), etc.

Some embodiments furthermore comprise generating and/or providing the access designator for the data (or causing the access designator to be generated and/or provided); and transmitting or transferring the access designator to the motor vehicle (or causing the access designator to reach the motor vehicle via the telematics connection). The transmission can take place via the telematics connection, or can take place via another connection, for example another telematics connection.

In some of these embodiments, the access designator and the one-time key are transferred or transmitted or sent independently of one another. For example, the one-time key can be transferred only in reaction to an authentication of a lawful user of the vehicle via the telematics connection. The authentication can take place, for example, in relation to the motor vehicle, based on the (or another) digital key, etc.

A second aspect of the present invention likewise relates to a method for transmitting data using a telematics connection for a motor vehicle. The method can be implemented in the motor vehicle, for example in a secure element. The method comprises receiving a one-time key for the data via the telematics connection; and forwarding the one-time key to a receiver of the data.

The secure element can be installed, for example, as part of an ECU (“Electronic Control Unit”) or can otherwise be part of a control unit in the vehicle. The receiver of the data can likewise be located in this or another control unit in the vehicle.

In some embodiments of this aspect of the invention, the telematics connection terminates in the motor vehicle in a secure component, for example a high-security zone.

Some embodiments of this aspect of the invention furthermore comprise receiving an access designator for the data (via the telematics connection, or by means of a communication channel which is separate from the secured telematics connection); and forwarding the access designator to the receiver of the data.

The forwarding of the one-time key and/or the access designator can take place by means of a communication connection or a communication channel in the vehicle. In some embodiments, the forwarding takes place via a communication connection secured end to end.

A third aspect of the present invention likewise relates to a method for transmitting data using a telematics connection for a motor vehicle. The method can be implemented in the motor vehicle, for example in a receiver of the data. The method comprises receiving a one-time key for the data, which is forwarded from an endpoint of the telematics connection (for example, from a secure memory or secure element in the motor vehicle); and decrypting the data by means of the one-time key.

Some embodiments of this aspect of the invention furthermore comprise receiving an access designator (this can be forwarded from the endpoint of the telematics connection, or can be received in other ways); and requesting or retrieving the data by means of the access designator. The data can be provided or retrieved, for example, by a content delivery network (CDN).

In some embodiments of the aspects of the invention outlined up to this point, the one-time key (224) is not stored persistently, neither in the backend, nor in the motor vehicle, nor at any other point.

A further aspect of the present invention relates to a backend server, in particular a central vehicle producer server and/or a key tracking server, which is designed to carry out a corresponding method described herein according to the first aspect of the invention.

Still another aspect of the present invention relates to a control unit for transmitting data using a telematics connection for a motor vehicle. The control unit can provide, for example, an endpoint of a secured telematics connection in the motor vehicle. The control unit is designed to carry out a method described herein according to the second aspect of the invention.

Still another aspect of the present invention likewise relates to a control unit for transmitting data using a telematics connection for a motor vehicle. The control unit can comprise, for example, for receiving and processing data which are sensitive or worthy of protection in the motor vehicle. The control unit is designed to carry out one of the methods described herein according to the third aspect of the invention.

Each of the above-mentioned control units can be present as an independent unit in the motor vehicle, or can be present integrated into another unit, for example into an ECU (“Electronic Control Unit”), a head unit, etc. The two control units can also both be present in a common ECU, for example in a head unit.

Each of the above-mentioned control units can comprise a secure memory, a secure element, etc. or can have independent access thereto.

Still another aspect of the present invention relates to a motor vehicle which comprises a control unit described herein for transmitting data using a telematics connection for the motor vehicle according to the second aspect of the invention, and a control unit described herein for transmitting data using a telematics connection for the motor vehicle according to the third aspect of the invention.

One aspect of the present invention relates to a system for transmitting data using a telematics connection for a motor vehicle which comprises the motor vehicle (as described herein) and a backend server, in particular a central vehicle producer server and/or key tracking server as described herein.

The invention will now be described in more detail with reference to the appended drawings, in which:

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 illustrates a first exemplary embodiment of a system according to the invention;

FIG. 2 illustrates a second exemplary embodiment of a system according to the invention;

FIG. 3A illustrates a flow chart of a first exemplary embodiment of a method according to the invention;

FIG. 3B illustrates a flow chart of a second exemplary embodiment of a method according to the invention;

FIG. 3C illustrates a flow chart of a third exemplary embodiment of a method according to the invention; and

FIG. 4 illustrates a flow chart of a fourth exemplary embodiment of a method according to the invention.

### DETAILED DESCRIPTION OF THE DRAWINGS

A secure memory or a secured environment, a secure zone, a secure or secured element, etc. can be based, for example, on a corresponding chip, a cryptographic processor, etc. For example, the secure memory can be a HSM (“Hardware Security Module”), TPM (“Trusted Platform Module”), a secured element (“Secure Element”, “Secure Enclave”), a TEE (“Trusted Execution Environment”) etc. A secure memory or a secure element can be designed, for example, for storing or depositing at least one cryptographic, electronic, or digital key including metadata. For example, a secure memory can be designed for depositing at least one cryptographic or digital vehicle key, wherein the latter can be stored, for example, in the form of an endpoint according to CCC.

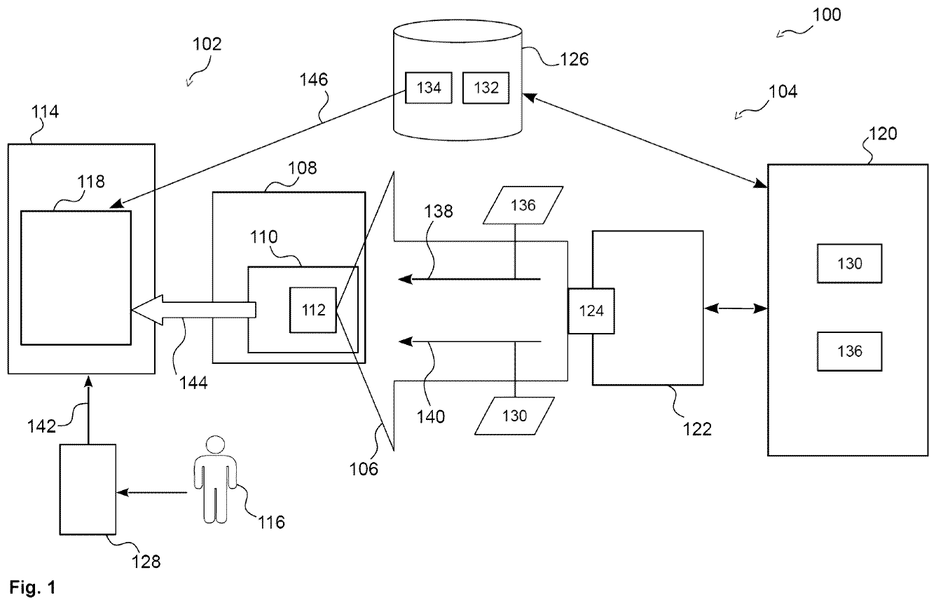

FIG. 1 shows in schematic form a system 100 having a motor vehicle 102 and a backend, provided in general with the reference sign 104, for the vehicle 102, which can be operated, for example, by a producer of the vehicle 102. A telematics connection 106 can exist, be established, and be operated, etc. between the vehicle 102 and the backend 104 and can be used for a data transmission as described hereinafter.

An ECU 108 is installed in the vehicle 102, which comprises a secure memory 110. The secure memory 110 provides an endpoint 112 for the secure telematics connection 106 in the vehicle 102. Furthermore, a further ECU is present in the vehicle, which is referenced here as a head unit 114. Personal data of a vehicle user 116 are processed in the head unit 114, for example in an app which is referenced here in general as a data receiver 118. A synchronization of the personal data between the data receiver 118 and the backend 104 requires special security measures such as a data transmission which is encrypted and/or otherwise secure.

The ECU 108 having the endpoint 112 of the telematics connection 106 is represented as a separate unit for reasons of clarity and for easier understanding, but could also be part of another component, such as the head unit 114.

The backend 104 comprises a functional backend server 120, for example a central vehicle producer server according to CCC, and a key management server 122 for secure key management. The key management server 122 provides an endpoint 124 for the telematics connection 106.

The system 100 furthermore comprises a data storage server 126, for example a CDN, a “Data Repository”, a Web server, a component of a data cloud, etc. The data storage server 126 can be part of the backend 104, thus operated by the vehicle producer, or can be operated by an independent operator.

In recent time, a head unit in the vehicle sector (such as the head unit 114 in FIG. 1) not only accommodates a car radio, but rather functions as a central component, for example as a control component of an audio system in the vehicle, and also assumes further tasks and functions. For example, the head unit 114 can provide a general interface such as an HMI (“human machine interface”) between the user 116 and the vehicle 102, via which, for example, an optical or visual output and/or input can take place on a display or the like, acoustic inputs and outputs can be effectuated, etc.

In this case (increasingly in the future) personal settings or data, personalization information, etc. can be stored and processed in the head unit 114 (or connected components). Such data can also relate, for example, to configurations of a terminal 128 of the user 116 when it connects to the head unit 116. This personal data has to be securely received, processed, and stored by the receiver of the data 118 or the head unit 114.

In addition, at least in parts, a synchronization of person-related data is necessary between the backend 104 and the head unit 114. One example of this is person-Attorney related tokens, ID tokens, which are required for access to personal data. Such a token can be bound, for example, to a digital key (not shown) of the user 116, thus can be part of its metadata, for example. An ID token can have a size (scope of data) of up to 32 kB (kilobytes) in this case, i.e. a data block having corresponding size is to be transmitted to the data receiver or the receiver component 118. The receiver component 118 then uses the token to access remote resources, such as personal data.

It will be described on the basis of the configuration shown in FIG. 1 how a secure data transmission typically runs between backend 104 and vehicle 102. The vehicle 102 has a telematics system having the endpoint 112, which interacts with the endpoint or the remote station 1124 in the backend 104 in order to provide a secure data transmission via the telematics channel 106. In contrast to the simplified representation in FIG. 1, there can be not only a telematics connection 106 between vehicle 102 and backend 104, but rather there can be multiple different channels having different bandwidths, etc., which can lead to different endpoints in the vehicle 102, can use different security mechanisms, etc. The invention can thus also be implemented accordingly as described here with respect to the telematics connection 106 for other telematics connections between backend 104 and vehicle 102.

It is assumed by the telematics channel 106 that it offers a high level of security, for example using methods for (asymmetrical) encryption between the endpoints 112 and 124, etc. However, in the case of ECUs installed in practice in vehicles, such as the ECU 108 in FIG. 1, the available hardware resources (processor power, working memory, etc.) are so limited that a bandwidth of the telematics channel 106 is accordingly also limited. As a result, a data block having a size of 32 kB as described above is a “large” data block in the sense that a transmission via the telematics channel 106 takes too long, is susceptible to interference, etc., that a use of the ID token is inappropriately delayed, other functions of the ECU 108, the head unit 114, etc. in the vehicle 102 are inappropriately delayed, etc.

From a certain perspective, which is not to be understood as restricted, therefore a one-time key 130 is generated according to the invention in the backend 104. More precisely, the one-time key 130 can be generated in the functional backend server 120 or in the data storage server 126. Using this key 130, which can be a symmetrical key, certain data, in the example a data block 132 which is sensitive (worthy of protection) (such as an ID token) are encrypted on the data storage server 116 and stored as an encrypted sensitive data block 134 for the receiver component 118 in the vehicle 102.

Stated generally, the data block 132 can be encrypted in the backend server 120 or the data storage or provision server 126. The one-time key 130 can be generated, for example, on the data storage server 126 and the data block 132 can immediately be encrypted using the one-time key 130. The one-time key 130 is then given via a secure transmission path from the provision server 126 to the functional backend server 112 or directly to the key management server 122, i.e. to the endpoint 124 of the secure telematics connection 106. Other constellations are conceivable.

In addition, an access designator 136 (i.e. resource localization information) is generated in the data storage server 126 (or in the functional backend server 120). The encrypted data block 134 can be retrieved from the data storage server 126 using the access designator 136. The access designator 136 can comprise a URI, a URL, etc. and/or can be based on a concept of an operator of the data storage server 126. For easier understanding, it is initially presumed that the access designator 136 (like the one-time key 130) is likewise given from the data storage server 126 to the endpoint 124 of the telematics connection 106, however, it is to be noted that special security does not have to be provided for the access designator 136, i.e. the access designator 136 can, for example, be forwarded, stored, etc. in unencrypted form.

The one-time key 130 and/or the access designator 136 are transmitted via the secure telematics channel 106 to the vehicle 102, for example as part of the metadata of a digital key during a synchronization of these data between backend 104 and vehicle 102. Neither the unencrypted data block 132 nor the encrypted data block 134 are transmitted via the secure telematics channel 106.

The transmission of one-time key 130 and/or access designator 136 can take place in a single transmission procedure or, as indicated in FIG. 1, in two separate transmission procedures, i.e. in a chronologically first or leading transmission 138 only the access designator 136 is transmitted via the channel 106 and in a separate, independent chronologically second or trailing transmission 140, only the one-time key 130 is transmitted.

In this case, for example, the transmission 138 of the access designator 136 can be caused in that the data block 134 was provided in the data storage server 126. The transmission 140 of the one-time key 130, which enables decryption of the data block 134 in the vehicle 102, can first take place, for example, when the user 116 (to whom the data of the data block 132 or 134 are assigned) has authorized the use of the data of the data block 132 or 134 in the vehicle 102. Such an authorization can comprise, for example, an authentication 142 of the user 116 with respect to the vehicle 102 by means of the terminal 128.

As stated, the endpoint 112 of the high-security telematics channel 106 is located in a high-security area of the vehicle 102, i.e. in the secure memory 110 (in the exemplary embodiment of FIG. 1; other constellations are conceivable). From here, the one-time key 130 and/or the access designator 136 can be transmitted in a secure or protected manner to the data receiver or the receiving component 118. This can take place, for example, by means of a channel 144 having end-to-end encryption, which is provided in the vehicle 102; this channel can extend, for example, via another ECU or multiple other ECUs, for example as part of a communication system, bus system, etc. in the vehicle 102.

The receiver component 118 can initiate a retrieval 146 of the encrypted data block 134 from the data storage server 126 based on the access designator 136. The retrieval 142 of the data block 134 can take place via a telematics connection or a telematics channel (not shown in FIG. 1), which does not have to be especially secure or protected, because an attacker who downloads the encrypted data block 134 can do nothing further with the downloaded data.

After the retrieval or download 142, the encrypted data block 134 has to be decrypted. The one-time key 130 is required for the decryption, which is loaded via the secure telematics channel 106 into the vehicle. As stated, a transmission of the one-time key can take place, for example, only after a successful user authentication 142. If data synchronizations as described here are carried out more frequently, it can also be sufficient for performing such a synchronization, in particular downloading the relevant one-time key, if, for example, the terminal 128 of the user 116 is detected in the vehicle 102.

After the decryption in the data receiver 118, the data block 132 can be securely stored for later use by the receiver component 118 or the head unit 114. The one-time key 130 is only used for the encryption of the data block 132 in the data storage server 126 or decryption of the data block 134 at the data receiver 118 in the vehicle 102 and can then be discarded. In other words, persistent storage of the one-time key is not necessary, neither in the backend 104 nor in the vehicle 102.

In the exemplary embodiment described on the basis of FIG. 1, the access designator 136 is transmitted in the same way (via the secure telematics connection 106) to the vehicle as the one-time key 130. In other exemplary embodiments, the access designator can be transmitted in another way to the vehicle 102, for example not via the endpoint 112 or ECU 108, but rather via an unsecured telematics channel directly to the data receiver 118. The high-security telematics channel 106 is exclusively used for the transmission of the one-time key 130 in this example.

In the exemplary embodiment described here on the basis of FIG. 1, the data block 132 can, additionally or alternatively to an ID token, comprise extensive metadata of a digital key and/or other extensive and sensitive data or useful data, which can be loaded according to the invention into the vehicle 102 without the telematics channel 106 having its low capacity or bandwidth having to be used or overloaded for this purpose. Therefore, on the one hand, the telematics connection 106 is available for transmitting other sensitive data; for example, the telematics channel 106 can be used according to the invention to synchronize or keep synchronized a large number of receiver components in the vehicle, without interference or delays occurring during transmissions via the high-security telematics channel 106.

At the same time, the synchronization of extensive sensitive data blocks can take place in a secure manner and nonetheless with comparatively high bandwidth (depending on the availability of regular, i.e. unsecured telematics channels), because a transmission of (encrypted) data which is not specially secured minimizes, in comparison to an encrypted transmission, interference, aborts, repeated downloading, etc., thus optimizes the use of generally available bandwidth to the vehicle 102.

The use of a one-time key proposed according to the invention does not mean a compromise in the security, because in general the one-time key is used immediately after creation and then discarded. The use of the one-time key reduces a complexity in comparison to, for example, asymmetrical encryption methods, however, because the one-time key is not persistently stored.

More precisely, in a conventional procedure, with respect to the constellation of FIG. 1, the receiver component 118 would keep ready its own cryptographic key, for example an asymmetrical cryptographic key, and the backend 104 would hold a public key component thereto. This means that the backend 104 would have to store and manage one (public) key per receiver component and vehicle. In other words, the backend 104, for example the key management server 122, would have to manage many millions of cryptographic keys under certain circumstances, which would mean significant complexity and substantial effort. This effort is eliminated by the invention.

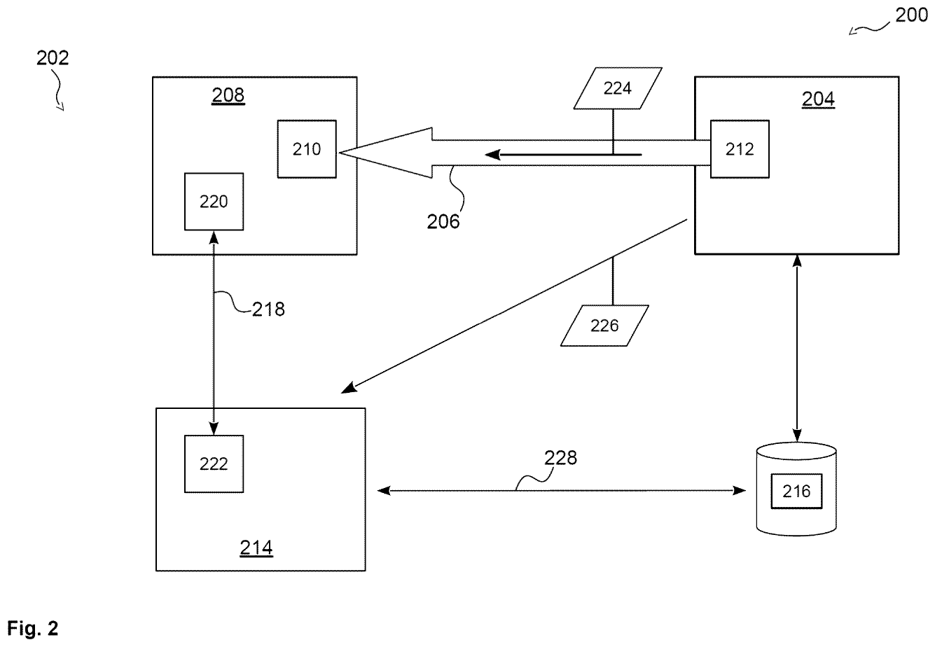

FIG. 2 shows, in the form of a schematic block diagram, a further exemplary embodiment of a system 200 having a motor vehicle 202 as well as a server 204 in a backend for the vehicle 202. A telematics connection or a telematics channel 206 enables a secure transmission of data between backend 204 and vehicle 202.

A secure component 208 in the vehicle 202 provides an endpoint 210 of the telematics connection 206. The secure component 208 can be present in the form of a secure memory, a secure element, a corresponding cryptographic processor, etc. and can be operated in a dedicated manner for providing the endpoint 210 or can additionally be provided for other functions, for example, in an ECU, head unit, etc. The other endpoint 212 of the telematics connection 206 is provided by the backend server 204, wherein the term “endpoint” means here that, for example, end-to-end encryption takes place via the telematics connection 206 between the endpoints 210 and 212.

Furthermore, a receiver component 214 of sensitive useful data 216 is present in the vehicle 202, i.e. the useful data 216 (such as tokens) are provided for a secure, i.e. encrypted transmission to the receiver component 214 in the vehicle 202. The receiver component 214 can (like the secure component 208) likewise be present, for example, in the form of a secure memory or can be implemented as a secure element, secure zone, etc., can be embedded in an ECU, etc. In one exemplary embodiment, between secure component 208 and receiver component 214, a vehicle-internal secured connection or a secure (for example end-to-end encrypted) channel 218 is present between an endpoint 220 in the secure component 208 and an endpoint in the receiver component 214.

The components of the system 200 shown in FIG. 2 cooperate to transmit the useful data 216 in a secured manner, i.e. encrypted, from the backend 204 to the vehicle 202, more precisely to the receiver component 214. The useful data 216 have a scope which can overload a transmission capacity, bandwidth, etc. of the secured telematics connection 206, in the sense that disturbances during the transmission, blockages in the endpoint 210, etc., can occur, which can have a disadvantageous effect on other functionalities, in particular on those other functions (for example safety-relevant functions), which run in the secure component 208, and/or also on functions which relate, for example, to the reception of other data via the secure telematics channel 206, so that its effectively available capacity is reduced even further than would be the case with an interference-free transmission of the useful data 216. According to the invention, a download or a retrieval of the data 216 via the telematics connection 206 can be avoided, and therefore also a blockage of other functions of the secure component 208 and/or the telematics connection 206.

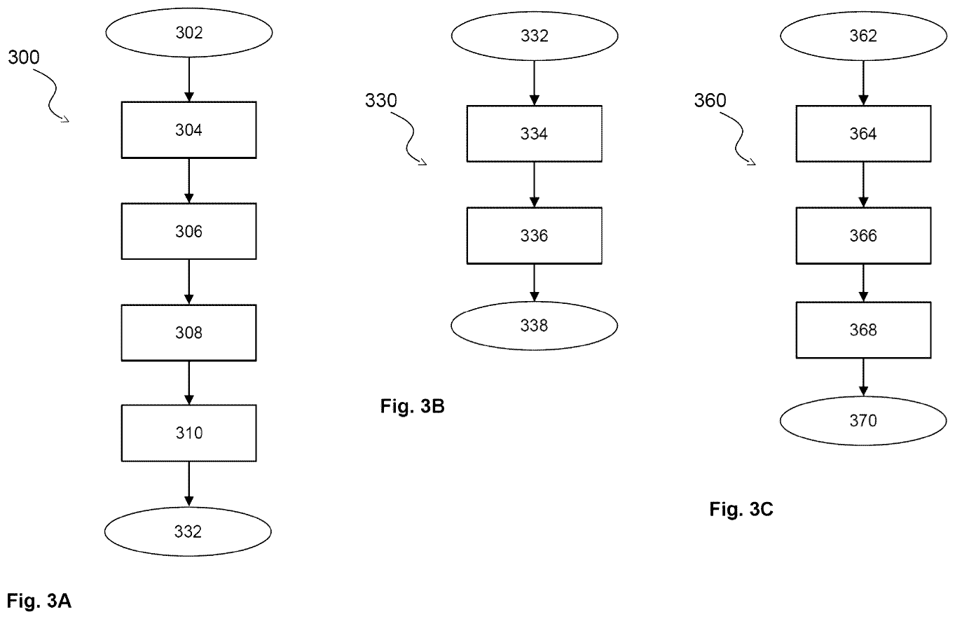

A specific sequence for a corresponding data transmission in the system 200 will be described in more detail hereinafter with reference to the sequences schematically shown in FIGS. 3A, 3B, and 3C. In this case, FIG. 3A shows a sequence of a method 300 for controlling the data transmission with the aid of the telematics connection 206 in the backend server 204. FIG. 3B shows a sequence of a corresponding method 330 in the secure component 208. FIG. 3C shows a sequence of a corresponding method 360 in the receiver component 210.

A sequence begins in the method 300 in FIG. 3A in a step 302 with the provision of the sensitive useful data 216 for the transmission. The useful data can comprise, for example, metadata for a digital key, as discussed herein at various points, and can comprise, for example, an ID token. In other exemplary embodiments, the data comprise generally person-related information, personal configuration data, personalization data, etc. or very generally sensitive data, in the sense that these data are to be transmitted in encrypted form, have to be stored in encrypted form in the vehicle in the receiver component 214, etc., wherein the data 216 are of such a large scope that they are unsuitable for a (for example block by block) transmission via the telematics connection 206, because this, for example, would block the telematics connection 206 for an excessively long time, would result in disturbances of other functionalities, etc. The term “unsuitable” means here that such a transmission is avoided if there is another possibility which is to be preferred and such a possibility according to the invention is described here.

In a step 304, a one-time key 224 is generated. The one-time key 224 can be generated in the backend server 204, for example immediately before following step 306, in which the sensitive useful data 216 are encrypted using the one-time key 224. In a step 308, an access designator 226 for the data 216 is provided. If the data are provided for retrieval in an external data memory (“data repository”), CDN, etc., the backend 204 can request, for example, a link or another resource localization information for the provided data 216 therefrom and provide it as the access designator 226.

In a step 310, the backend 204 transmits the access designator 226 to the motor vehicle 202. This can take place in encrypted form, thus, for example, via the secured telematics connection 206, or can also take place in unencrypted form, thus, for example, via an arbitrary unsecured connection between backend 204 and vehicle 202, because an attacker cannot make use of the encrypted data 216 without the one-time key 224. Encrypted transmission of the access designator 226 only slightly occupies the resources of the telematics channel 206 in general, however, in comparison to a transmission of the useful data 216 via the telematics channel 206, and therefore, for example, a joint transmission of access designator 226 and one-time key 224 can be preferable to a separate transmission depending on the circumstances of the individual case.

In a corresponding step 332 (method 330 in FIG. 3B), the secure component 208 (more precisely the endpoint 210) receives the access designator 226 via the telematics connection 206 or another, for example unsecured communication channel. In a step 334, the secure component 208 forwards the access designator 226 to the receiver component 214. This can take place via the vehicle-internal secured connection 218 or via another, for example unsecured connection.

In a corresponding step 362 (method 360 in FIG. 3C), the receiver component 214 receives the access designator 226 for the useful data 216 from the secure component 208. In a step 364, the receiver component 210 retrieves the encrypted sensitive useful data 216 by means of the access designator 226 (the data retrieval is indicated as procedure 228 in FIG. 2).

In a step 312 in method 300 in FIG. 3A, the one-time key 224 is transmitted via the telematics connection 206 to the motor vehicle 202. In one exemplary embodiment, access designator 226 and one-time key 224 can be sent together via the telematics connection 206, i.e. steps 310 and 312 are carried out jointly or in parallel. In another exemplary embodiment, access designator 226 and one-time key 224 are sent or transmitted separately, and it is necessary here for at least the one-time key 224 to be transmitted in a protected manner, i.e. via the secure telematics connection 206, to the vehicle 202.

In a preferred exemplary embodiment, the one-time key 224 is transmitted in reaction to an approval of a vehicle user, wherein obtaining the approval can be triggered, for example, by the retrieval of the data in step 364 (data retrieval 228 in FIG. 2) or already in conjunction with providing the useful data in step 302 (method 300 in FIG. 3A). The obtaining of the approval can be controlled, for example, by the receiver component 214 and can comprise an authentication of the user (for example by means of their terminal, key fob, etc.). The sequence specific to the invention is therefore ended in the backend 204. In particular, secure storage of the one-time key 224 is not required, it can be discarded, possibly after receiving a confirmation from the vehicle 202 relating to a successful transmission of the sensitive useful data 216.

In a corresponding step 336 (method 330 in FIG. 3B), the secure component 208 receives the one-time key 224 via the secure telematics connection 206. In a step 338, the secure component 208 forwards the one-time key 226 to the receiver component 214 (if access designator 226 and one-time key 224 are transmitted jointly, steps 332 and 336, or 334 and 338 coincide in the secure component 208). The forwarding preferably takes place via the vehicle-internal secured connection 218, i.e. the endpoint 220. The sequence specific to the invention is therefore ended in the secure component 208.

In a corresponding step 366 (method 360 in FIG. 3C), the receiver component 214 (more precisely the endpoint 222 of the vehicle-internal secured connection 218) receives the one-time key 224 forwarded in a secured manner. In a step 368, the receiver component 210 uses the one-time key 224 and decrypts the sensitive data 216 previously retrieved by means of the access designator 226. In a step 370, the receiver component 210 processes the decrypted data 216, uses, for example, a received ID token, stores it in a secured manner, etc. The sequence specific to the invention is therefore ended in the receiver component 210.

As described, the telematics connection 206 between backend 204 and vehicle 202 is only used or required for sending the one-time key 224 (and possibly the access designator 226), while the sensitive useful data 216 (in encrypted form) can reach the vehicle 202 via an unsecured, unencrypted connection, which generally has a significantly higher capacity, bandwidth, etc. than a high-security connection like the telematics connection 206, so that an impairment of the telematics connection 206 can be avoided according to the invention.

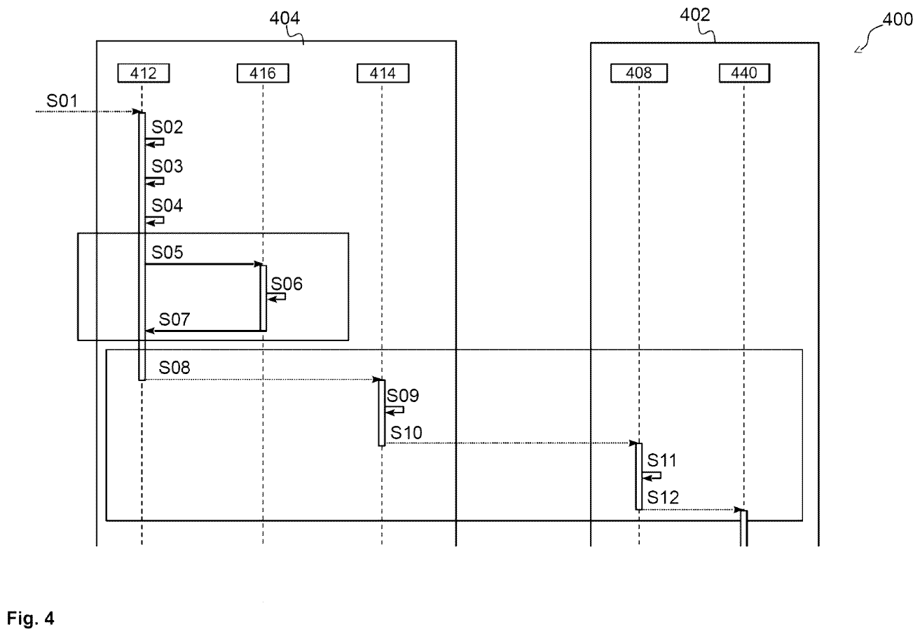

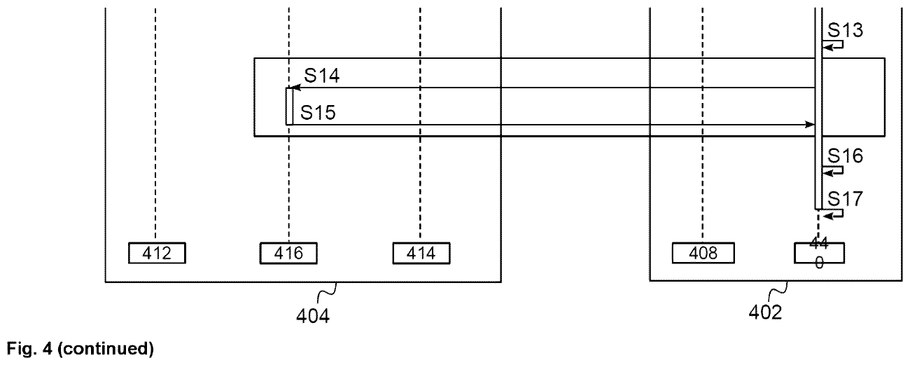

FIG. 4 illustrates, in the form of a schematic sequence diagram, a further exemplary embodiment of a method 400 for transmitting data by means of a telematics connection for a motor vehicle 402. In this case, a functional backend server 412, a key management server 414, and a CDN 416 are present in a backend designated in general by “404”. A secured element 408, as well as a client 440, are present in the vehicle 402.

The functional backend server 412 can be implemented, for example, in a central vehicle producer server according to CCC. The key management server 414 provides a high-security telematics endpoint and can be implemented, for example, in a key tracking server (KTS) according to CCC. The general backend 404 can be operated by a producer of the vehicle 402, however, for example, the CDN 416 can also be operated independently of the vehicle.

The secure element 408 functions as an endpoint of a secure telematics connection between vehicle 402 and backend 404. The client 440 is designed for the retrieval of useful data from the CDN 416, as described hereinafter. The client 440 can be implemented, for example, in the form of an app, which runs on a head unit of the vehicle 402. Secure element 408 and client 440 can be assigned to one ECU, or can be assigned to various ECUs.

The method 400 relates to handling sensitive data, in particular extensive data, wherein “extensive” is to be viewed in relation to a capacity of a secure telematics channel available for transmission. The data are “extensive” or “large” if the telematics channel is factually bandwidth-limited such that a smooth transmission is not ensured, wherein a disturbance can relate to the data transmission itself and also other functions, for example, of the secure element 408. One exemplary application can relate to handling a digital key having extensive metadata, which are to be transmitted via a high-security, but very limited telematics channel for the purposes of synchronization.

Stated generally, a digital key, for example a digital vehicle key according to CCC, can comprise metadata which have to be synchronized between backend 404 and the relevant vehicle 402. The metadata can comprise data which are sensitive or worthy of protection, for example security tokens which can be used as a proof of authentication. Such tokens can have a scope of 32 kB or more, as noted. However, other examples of much more extensive sensitive data are also conceivable, which relate, for example, to future scenarios in a CCC context.

A smooth transmission of such extensive sensitive data to the vehicle 402 cannot be ensured in practice via a high-security telematics channel, since the endpoint of the channel is located in an integrated secure memory, a high-security zone, a secure element, etc. having very limited resources. As already stated, the transmission of a large data block via such a secure element can also disadvantageously influence the performance of other functions.

Among other things, it is proposed according to the invention that a high-security telematics channel only transport encryption information (such as one-time keys) and possibly entry or access information (such as access designators), while the useful data per se, thus, for example, the metadata of a digital key, are transmitted via another path. In this way, the high-security transmission function of the telematics channel is still advantageously used, while the disadvantages accompanying the limited bandwidth are avoided.

An exemplary embodiment according to the invention of updating, refreshing, regenerating, or synchronizing extensive metadata of a digital key with (symmetric) encryption will be described in detail on the basis of the method 400.

In a step S01, a request reaches the functional backend server 412, which relates to generating or updating a “large” amount of sensitive data (referenced hereinafter in short as a “data block”), and what is to be understood as a “large” amount of data is discussed herein at various points. In a step S02, the functional backend server 412 generates or updates the data block. In a step S03, the functional backend server 412 generates a key for encryption, for example a symmetrical key, one-time key, etc. In a step S04, the functional backend server 412 encrypts the data block worthy of protection.

Steps S05-S07 relate to storing or providing the sensitive data block for external access or retrieval. How an access designator is generated in detail is dependent here on the circumstances of the individual case; the access designator could directly specify a URI path, or comprise a token for a retrieval of the resource. In step S05, the functional backend server 412 sends a request for a storage of the encrypted sensitive data block to the CDN 416. In step S06, the CDN 416 stores the encrypted sensitive data block. In step S07, the CDN 416 returns an access designator to the functional backend server 412.

In steps S08-S12, data with reference to the digital key are transmitted. These data have a small scope in comparison to the large sensitive data block, and therefore can be transmitted without problems via the above-described telematics channel. In step S08, the functional backend server 412 sends a request to the key management server 414. The request relates to forwarding the one-time key generated in step S03 and the access designator received in step S07 to the vehicle 402.

In step S09, the key management server 414 compiles an update of the data for the digital key for the vehicle 402. In a step S10, the key management server 414 transmits a request to the secure element 408. The request relates to forwarding the data for the digital key to the vehicle 402.

In step S11, the secure element 408 processes the received data for the digital key. In step S12, the secure element 408 initiates forwarding of the external data, i.e. the one-time key and the access designator, to the client 440. The forwarding can be transmitted, for example, via a secure channel encrypted end-to-end. The request can be forwarded via multiple ECUs.

In a step S13, the client 440 stores the one-time key and the access designator. In another exemplary embodiment (not shown), the secure element 408 can securely store the one-time key and the access designator until the linked digital key has been successfully authenticated. Steps S14-S15 relate to the transmission of the “large” data, i.e. the sensitive data block. In step S14, the client 440 sends a request to the CDN 416 relating to the sensitive data block. The request contains the access designator. In step S15, the CDN 416 returns the encrypted sensitive data block. In a step S16, the client 440 decrypts the encrypted sensitive data block using the one-time key. In step S17, the client 440 processes the sensitive data block. The sequence relevant to the invention is therefore ended in the method 400.

A conventional approach for handling “large” sensitive data can be that per vehicle, a large number of ECUs each hold a separate key, for example in the form of an asymmetrical key pair, wherein the public key component would have to be held in the backend in each case. This approach is complicated and cumbersome, even if or all the more if, for example, after a secure channel is established based on the key pair (in one direction), a symmetrical key is arranged for the actual transmission of the sensitive data block.

This applies accordingly if two such complex channels are connected in succession, wherein a single telematics channel (or a small number of telematics channels) is established to the vehicle (and this channel would also be frequently overloaded with this approach), but then a dedicated ECU in the vehicle would have to maintain a large number of channels for forwarding to the respective receiver ECU. Such a dedicated ECU or such a secure memory would have to be dimensioned for corresponding performance; a secure memory would thus have to be able to receive large data blocks via the external telematics channel, decrypt the data block, and then provide this data block for a new encryption for the vehicle-internal forwarding, and such an approach is likewise complex and costly.

In contrast, embodiments of the invention propose (at a viewing angle which is not to be understood as restrictive) that the endpoint for the actual data transmission (with symmetrical encryption) is shifted in relation to the endpoint for the secure data transmission via the telematics channel. In other words, the secure useful data transmission takes place separately from the secure transmission of control data such as the one-time key (using which the useful data transmission is secured) and/or the access identifier.

Embodiments of the invention therefore only require a secure channel for the transmission of data having a small scope, i.e. for this purpose, for example, a high-security telematics channel known per se is usable and sufficient. It is not necessary to keep a large number of public key components in the backend. Instead, only a one-time key is to be generated for each synchronization, which can be discarded after the transmission (in the backend and in the vehicle). At the same time, the secure telematics channel is only used for the transmission of the one-time key, so that a single such channel per vehicle can support a synchronization of a large number of internal ECUs with sensitive data such as personalization data, workshop data, insurance data, etc. without problems.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### REFERENCE SIGNS

100 system
102 (motor) vehicle
104 backend
106 telematics connection, telematics channel, channel
108 ECU
110 secure memory
112 endpoint of the telematics connection in the vehicle
114 head unit
116 user
118 data receiver, receiver component
120 functional backend server
122 key management server
124 endpoint of the telematics connection in the backend
126 data storage server
128 terminal
130 one-time key
132 sensitive data block (unencrypted)
134 sensitive data block (encrypted)
136 access designator
138 transmission of the access designator
140 transmission of the one-time key
142 user authentication
144 encrypted channel in the vehicle
146 retrieval, download
200 system
202 (motor) vehicle
204 backend, backend server
206 telematics connection
208 secure component in the vehicle
210 endpoint of the telematics connection in the vehicle
212 endpoint of the telematics connection in the backend
214 receiver component
216 sensitive useful data
218 internal secured connection
220 endpoint in the secure memory
222 endpoint in the receiver component
224 one-time key
226 access designator
228 data retrieval
300 method
302-332 method steps
330 method
332-338 method steps
360 method
362-370 method steps
400 method
402 vehicle
404 backend
408 secure element
412 functional backend server
414 key management server
416 CDN
440 client
S01-S17 method steps

What is claimed is:

1. A method for transmitting data using a telematics connection for a motor vehicle, the method comprising:
providing the data for the transmission;
providing a one-time key for the data; and
transmitting the one-time key via the telematics connection to the motor vehicle.

2. The method according to claim 1, wherein the data comprises metadata for a digital key.

3. The method according to claim 2, wherein the data comprises a security token.

4. The method according to claim 1, further comprising:
providing an access designator for the data; and
transmitting the access designator to the motor vehicle.

5. The method according to claim 1, wherein the one-time key is transmitted in reaction to an authentication of a user of the digital key.

6. The method according to claim 1, wherein the data is provided in encrypted form for a retrieval by means of the access designator.

7. A method for transmitting data using a telematics connection for a motor vehicle, the method comprising:
receiving a one-time key for the data via the telematics connection; and
forwarding the one-time key to a receiver of the data.

8. The method according to claim 7, wherein the telematics connection terminates in the motor vehicle in a secure component.

9. The method according to claim 7, further comprising:
receiving an access designator for the data; and
forwarding the access designator to the receiver of the data.

10. The method according to claim 7, wherein the forwarding of the one-time key takes place via a communication connection secured end-to-end.

11. A method for transmitting data using a telematics connection for a motor vehicle, the method comprising:
receiving a one-time key for the data, which is forwarded from an endpoint of the telematics connection; and
decrypting the data by means of the one-time key.

12. The method according to claim 11, further comprising:
receiving an access designator; and
retrieving the data by means of the access designator.

13. The method according to claim 1, wherein the one-time key is not persistently stored.

14. A backend server, configured to carry out a method for transmitting data using a telematics connection for a motor vehicle according to claim 1.

15. A control unit, configured to carry out a method for transmitting data using a telematics connection for a motor vehicle according to claim 7.

16. The control unit according to claim 15, comprising a secure memory configured to use in the the method for transmitting data using a telematics connection for a motor vehicle.

17. A motor vehicle, comprising at least one control unit configured to transmit data using a telematics connection for the motor vehicle according to claim 15.

18. A system for transmitting data using a telematics connection for a motor vehicle, comprising:
a backend server configured to:
provide data for a transmission;
provide a one-time key for the data; and
transmit the one-time key via the telematics connection to a motor vehicle. the motor vehicle, comprising at least one control unit configured to:
receive the one-time key for the data via the telematics connection; and
forward the one-time key to a receiver of the data; and [symbol]
